(19) United States
(12) Patent Application Publication
(10) Pub. No.: US 2018/0329390 A1
(43) Pub. Date: Nov. 15, 2018

(54) MACHINE TOOL

(71) Applicant: FANUC CORPORATION, Yamanashi (JP)

(72) Inventor: Chao Zhi, Yamanashi (JP)

(73) Assignee: FANUC CORPORATION, Yamanashi (JP)

(21) Appl. No.: 15/951,922

(22) Filed: Apr. 12, 2018

(30) Foreign Application Priority Data
May 11, 2017 (JP) 2017-094609

(51) Int. Cl. G05B 19/18; B23Q 3/155

(52) U.S. Cl. CPC G05B 19/182; G05B 2219/36503; G05B 2219/35354; B23Q 3/15503

(57) ABSTRACT

In a machine tool, a control device performs control on an axis member rotating device and a stage rotating device such that when part of a placement region RE in a stage is arranged in a position opposite a spindle cutter in a third direction, in a direction which is at least one of a first direction and a second direction and in which accuracy is required, a screw axis length from a connection portion of the screw axis member of a ball screw and an axis member rotating device to a nut portion is minimized and that the part of the placement region RE in the stage is moved to the position opposite the spindle cutter in the third direction.

This application is based on and claims the benefit of priority from Japanese Patent Application No. 2017-094609, filed on 11 May 2017, the content of which is incorporated herein by reference.

### BACKGROUND OF THE INVENTION

### Field of the Invention

The present invention relates to machine tools such as a machining center.

### Related Art

Conventionally, a machine tool is known in which an item to be machined is placed on a stage (work table), the work table is rotated or moved in an X axis direction and a Y axis direction such that the item to be machined is moved to a position opposite a spindle cutter and thus the item to be machined is machined (for example, see Patent Document 1).

Patent Document 1: Japanese Unexamined Patent Application, Publication No. S59-200305

### SUMMARY OF THE INVENTION

In the machine tool disclosed in Patent Document 1, the work table is moved for example by a ball screw or the like, and in the ball screw, a temperature increase or a thermal displacement occurs due to heat generation caused by friction. Consequently, an error occurs in the positioning of the item to be machined. In order to grasp an error caused by heat, it is necessary to use a thermal sensor or the like.

An object of the present invention is to provide a machine tool which can minimize an error in the positioning of an item to be machined without use of a thermal sensor or the like.

(1) A machine tool (for example, a machining center 1 which will be described later) of the present invention includes: a machine tool main body (for example, a bed 2 and a column 3 which will be described later); an axis member rotating device (for example, an X axis servomotor 46X, a Y axis servomotor 46Y and a Z axis servomotor 46Z which will be described later) which is fixed to the machine tool main body; a stage axis portion (for example, a table axis portion 51 which will be described later) which includes a rotating axis member that is rotatably supported with respect to the machine tool main body; a stage (for example, a work table 5 which will be described later) that is supported on the stage axis portion so as to be able to be moved with respect to the machine tool main body in at least one of a first direction (for example, an X axis direction which will be described later) and a second direction (for example, a Y axis direction which will be described later) perpendicular to the first direction and to be able to be rotated together with the rotating axis member and that includes a placement region (for example, a placement region RE which will be described later) on which one or a plurality of items to be machined (for example, a work W which will be described later) are respectively placed; a ball screw (for example, an X axis ball screw axis 45X and a Y axis ball screw axis 45Y which will be described later) whose base portion includes a screw axis member (for example, an X axis ball screw axis 45X, a Y axis ball screw axis 45Y and a Z axis ball screw axis 45Z which will be described later) that is rotatably supported by the axis member rotating device and a nut portion (for example, a nut portion 47X, 47Y, 47Z which will be described later) that is fixed to the stage axis portion and that is engaged with a portion on a tip portion side of the screw axis member and which moves the stage in at least one of the first direction and the second direction by rotation of the screw axis member with the axis member rotating device; a stage rotating device which rotates the stage through the stage axis portion; a spindle cutter (for example, a spindle portion 7 and a tool 77 which will be described later) which can be separated from and moved close to the stage in a third direction (for example, a Z axis direction which will be described later) perpendicular to the first direction and the second direction; and a control device which controls the axis member rotating device and the spindle cutter, where the control device performs control on the axis member rotating device and the stage rotating device such that when part of the placement region in the stage is arranged in a position opposite the spindle cutter in the third direction, in a direction which is at least one of the first direction and the second direction and in which accuracy is required, a screw axis length from a connection portion of the screw axis member of the ball screw and the axis member rotating device to the nut portion is minimized and that the part of the placement region in the stage is moved to the position opposite the spindle cutter in the third direction.

(2) Preferably, in the machine tool of (1), the two axis member rotating devices and the two ball screws are provided, the longitudinal direction of one of the screw axis members has a position relationship parallel to the first direction, and the longitudinal direction of the other of the screw axis members has a position relationship parallel to the second direction and the control device performs control on the axis member rotating device and the stage rotating device such that when the part of the placement region in the stage is arranged in the position opposite the spindle cutter in the third direction, the sum of the two screw axis lengths is minimized and that the part of the placement region in the stage is moved to the position opposite the spindle cutter in the third direction.

According to the present invention, it is possible to provide a machine tool which can minimize an error in the positioning of an item to be machined without use of a thermal sensor or the like.

### BRIEF DESCRIPTION OF THE DRAWINGS

FIG. 1 is a front view showing a machining center 1 according to an embodiment of the present invention;

FIG. 2 is a side view showing the machining center 1 according to the embodiment of the present invention;

FIG. 3 is a schematic plan view showing a position relationship of a work table 5, a work W, a tool 77, an X axis servomotor 46X and a Y axis servomotor 46Y in the machining center 1 according to the embodiment of the present invention;

FIG. 4 is a flowchart showing control performed by a control device 8 in the machining center 1 according to the embodiment of the present invention;

FIG. 5 is a schematic plan view showing a state where the work table 5 in the machining center 1 according to the embodiment of the present invention is rotated such that the work W is arranged in the position of 45°;

FIG. 6 is a schematic plan view showing a state where the work W is arranged in a position opposite a tool in the state where the work table 5 in the machining center 1 according to the embodiment of the present invention is moved such that the work W is located in the position of 45°;

FIG. 7 is a schematic plan view showing a state where the work table 5 in the machining center 1 according to the embodiment of the present invention is rotated such that the work W is arranged in the position of 0°;

FIG. 8 is a schematic plan view showing a state where the work W is arranged in a position opposite the tool in the state where the work table 5 in the machining center 1 according to the embodiment of the present invention is moved such that the work W is located in the position of 0°;

FIG. 9 is a schematic plan view showing a state where the work table 5 in the machining center 1 according to the embodiment of the present invention is rotated such that the work W is arranged in the position of 90°;

FIG. 10 is a schematic plan view showing a state where the work W is arranged in a position opposite the tool in the state where the work table 5 in the machining center 1 according to the embodiment of the present invention is moved such that the work W is located in the position of 90°; and

FIG. 11 is a graph showing variations in the values of sin θ, cos θ and sine θ+cos θ when the angle by which the work table 5 in the machining center 1 according to the embodiment of the present invention is rotated is varied.

### DETAILED DESCRIPTION OF THE INVENTION

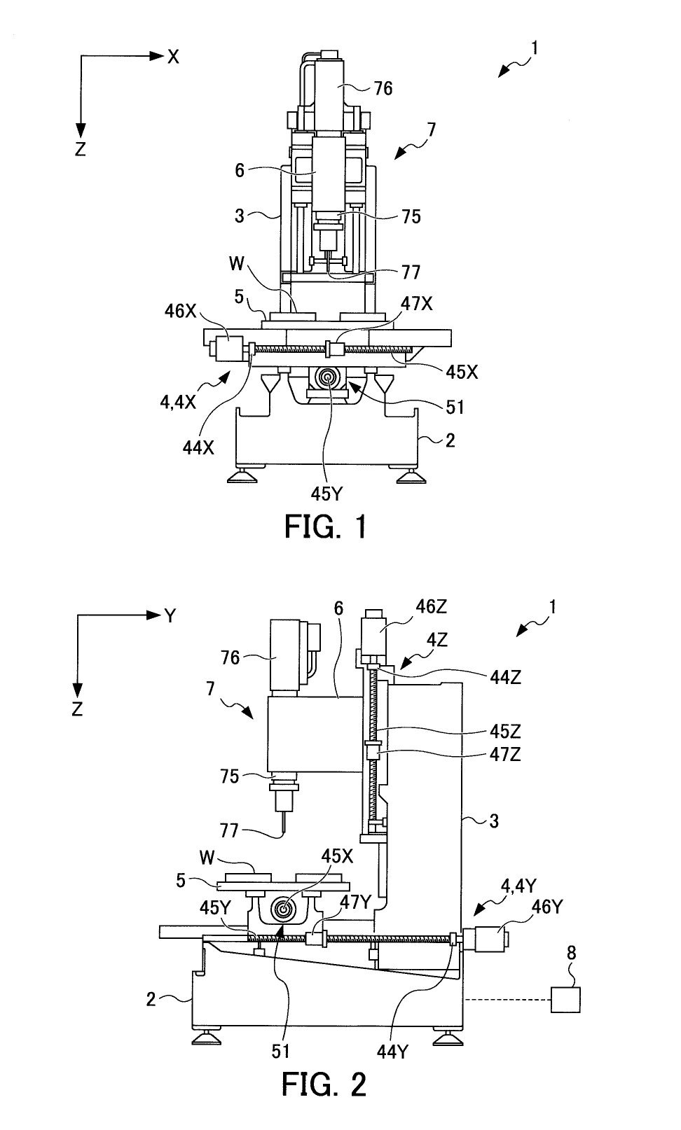

An embodiment of the present invention will be described below. FIG. 1 is a front view showing a machining center 1 according to the embodiment of the present invention. FIG. 2 is a side view showing the machining center 1 according to the embodiment of the present invention. A machine tool according to the present embodiment is formed with the machining center 1.

As shown in FIGS. 1 and 2, the machining center 1 includes a bed 2 and a column 3 which serve as a tool machine main body, feed axes 4, a work table 5 which serves as a stage, a spindle mounting base 6, a spindle portion 7 and a control device 8.

The feed axes 4 include: a feed axis 4X which is extended so as to have a position relationship parallel to an X axis direction (left/right direction in FIG. 1) that is a first direction; a feed axis 4Y which is extended so as to have a position relationship parallel to a Y axis direction (left/right direction in FIG. 2) that is a second direction; and a feed axis 4Z which is extended so as to have a position relationship parallel to a Z axis direction (up/down direction in FIG. 2) that is a third direction. The feed axis 4X in the X axis direction and the feed axis 4Y in the Y axis direction are provided above the bed 2, and the feed axes 4X and 4Y move the horizontal work table 5 on which works (items to be machined) W are mounted in a horizontal direction (the X axis direction and the Y axis direction) with respect to the bed 2 and the column 3.

Specifically, the feed axis 4X in the X axis direction is formed with a ball screw which includes an X axis ball screw axis 45X serving as a screw axis member, an X axis servomotor 46X serving as an axis member rotating device, a nut portion 47X and a ball (unillustrated). A base end portion of the X axis ball screw axis 45X is connected with a coupling 44X to the output axis (rotating axis) of the X axis servomotor 46X fixed to the bed 2 and the column 3. In the X axis ball screw axis 45X, the base end portion is rotatably supported by the X axis servomotor 46X, and the X axis ball screw axis 45X is rotated together with the output axis of the X axis servomotor 46X.

A female screw thread which is formed in the inner circumferential surface of the nut portion 47X is engaged, through the ball (unillustrated) formed with a steel ball, with a male screw thread which is in a portion on a tip portion side with respect to the base end portion of the X axis ball screw axis 45X connected to the coupling 44X and which is formed in the circumferential surface of the X axis ball screw axis 45X. The X axis ball screw axis 45X is rotated, and thus the nut portion 47X is moved in the axial direction of the X axis ball screw axis 45X. The nut portion 47X is fixed to the rotating axis support portion of a table axis portion 51, which will be described later, in the work table 5. The output axis of the X axis servomotor 46X is rotated together with the X axis ball screw axis 45X, and thus the work table 5 is moved along the X axis ball screw axis 45X in the X axis direction.

The feed axis 4Y in the Y axis direction is formed with a ball screw which includes a Y axis ball screw axis 45Y, a Y axis servomotor 46Y serving as an axis member rotating device, a nut portion 47Y and a ball (unillustrated). A base end portion of the Y axis ball screw axis 45Y is connected with a coupling 44Y to the output axis (rotating axis) of the Y axis servomotor 46Y fixed to the bed 2 and the column 3. In the Y axis ball screw axis 45Y, the base end portion is rotatably supported by the Y axis servomotor 46Y, and the Y axis ball screw axis 45Y is rotated together with the output axis of the Y axis servomotor 46Y.

A female screw thread which is formed in the inner circumferential surface of the nut portion 47Y is engaged, through the ball (unillustrated) formed with a steel ball, with a male screw thread which is in a portion on a tip portion side with respect to the base end portion of the Y axis ball screw axis 45Y connected to the coupling 44Y and which is formed in the circumferential surface of the Y axis ball screw axis 45Y. The Y axis ball screw axis 45Y is rotated, and thus the nut portion 47Y is moved in the axial direction of the Y axis ball screw axis 45Y. The nut portion 47Y is fixed to the rotating axis support portion of the table axis portion 51, which will be described later, in the work table 5. The output axis of the Y axis servomotor 46Y is rotated together with the Y axis ball screw axis 45Y, and thus the work table 5 is moved along the Y axis ball screw axis 45Y in the Y axis direction.

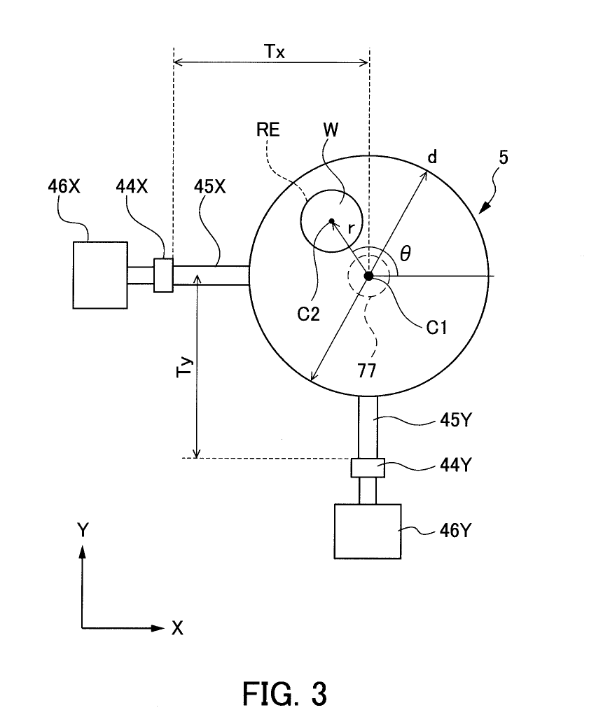

As shown in FIG. 3, the work table 5 is formed in the shape of a disk which has a diameter d, and the upper surface of the work table 5 has four placement regions RE where four works W serving as items to be machined having the same shape can be respectively placed at regular intervals in the circumferential direction of the upper surface of the work table 5. FIG. 3 is a schematic plan view showing a position relationship of the work table 5, the work W, a tool 77, the X axis servomotor 46X and the Y axis servomotor 46Y in the machining center 1 according to the embodiment of the present invention. The placement region RE has a circular shape, and as shown in FIG. 3, the center C2 of the placement region RE is separated a distance r from the center C1 of the work table 5. For convenience of description, in FIGS. 3 and 5 to 10, only one work W and one placement region RE are illustrated. The figures are shown such that the outer circumference of the work W coincides with the outer circumference of the placement region RE.

As shown in FIG. 1 and the like, below the center C1 of the work table 5, the table axis portion 51 is provided as a stage axis portion. The table axis portion 51 includes, as rotating axis members, a table rotating axis (unillustrated) and the rotating axis support portion (unillustrated). The table rotating axis (unillustrated) is connected to a lower portion of the work table 5, and is rotated together with the work table 5 with respect to the bed 2 and the column 3. The rotating support portion (unillustrated) rotatably supports the table rotating axis with respect to the bed 2. A motor (unillustrated) serving as a stage rotating device is coupled to the table rotating axis. The motor (unillustrated) is driven, and thus the table rotating axis and the work table 5 are rotated together.

The column 3 is extended upward from the bed 2. The feed axis 4Z in the Z axis direction is fixed to the front surface portion of the column 3, and the feed axis 4Z moves the spindle mounting base 6 in a vertical direction (Z axis direction).

Specifically, the feed axis 4Z in the Z axis direction includes a Z axis ball screw axis 45Z, a Z axis servomotor 46Z, a nut portion 47Z and a ball (unillustrated). A base end portion of the Z axis ball screw axis 45Z is connected with a coupling 44Z to the output axis (rotating axis) of the Z axis servomotor 46Z, the base end portion is rotatably supported by the Z axis servomotor 46Z and the Z axis ball screw axis 45Z is rotated together with the output axis of the Z axis servomotor 46Z.

A female screw thread which is formed in the inner circumferential surface of the nut portion 47Z is engaged, through the ball (unillustrated) formed with a steel ball, with a male screw thread which is in a portion on a tip portion side with respect to the base end portion of the Z axis ball screw axis 45Z connected to the coupling 44Z and which is formed in the circumferential surface of the Z axis ball screw axis 45Z. The Z axis ball screw axis 45Z is rotated, and thus the nut portion 47Z is moved in the axial direction of the Z axis ball screw axis 45Z. The nut portion 47Z is fixed to the spindle mounting base 6. The output axis of the Z axis servomotor 46Z is rotated together with the Z axis ball screw axis 45Z, and thus the spindle mounting base 6 and the spindle portion 7 are moved along the Z axis ball screw axis 45Z in the Z axis direction so as to be separated from and moved close to the work table 5.

The spindle mounting base 6 is extended to one side (front side) in the Y axis direction from the front surface portion of the column 3, and the spindle portion 7 is supported on the extended end portion (front end portion) of the spindle mounting base 6. The spindle portion 7 includes a spindle 75 and a spindle motor 76, and drives the spindle motor 76 so as to rotate the spindle 75. The spindle 75 is located above the work table 5, and the tool 77 serving as a spindle cutter is fitted to the lower end portion of the spindle 75. The tool 77 can be separated from and moved close to the work table 5 in the Z axis direction.

The control device 8 includes a CPU, a ROM and a RAM. The CPU reads, through a bus, a system program stored in the ROM, controls, according to the system program or by the input of signals from sensors (unillustrated) provided in the individual portions to the CPU, the X axis servomotor 46X, the Y axis servomotor 46Y, the Z axis servomotor 46Z, the spindle motor 76 and the motor (unillustrated) and the like forming the stage rotating device and thus drives the work table 5 and the spindle 75. In the RAM, temporary calculation data and display data are stored.

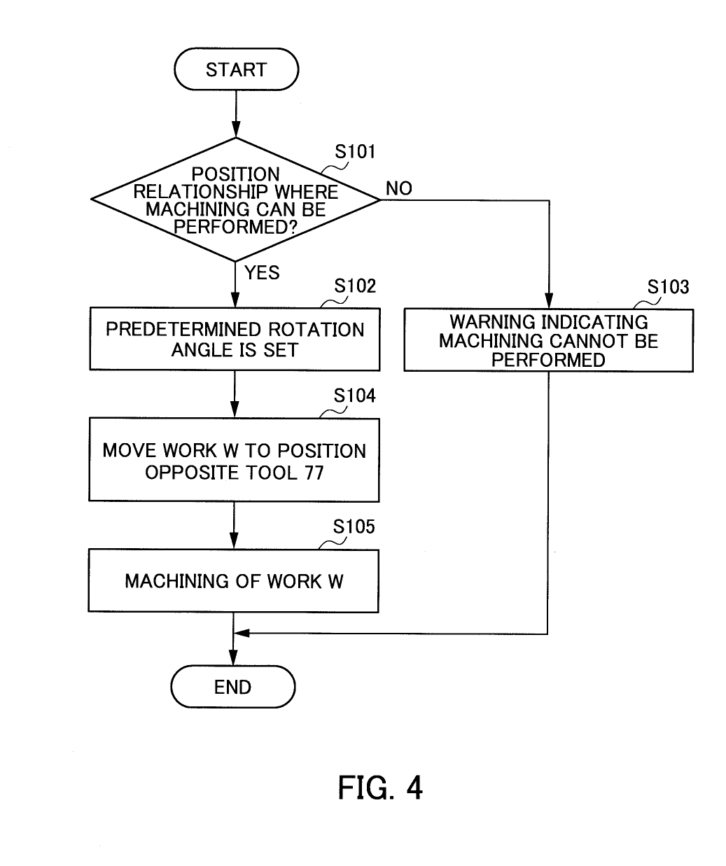

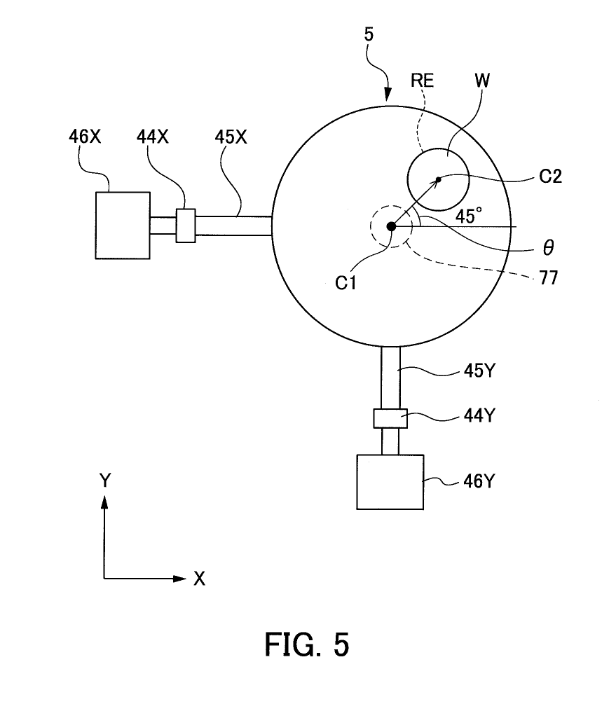

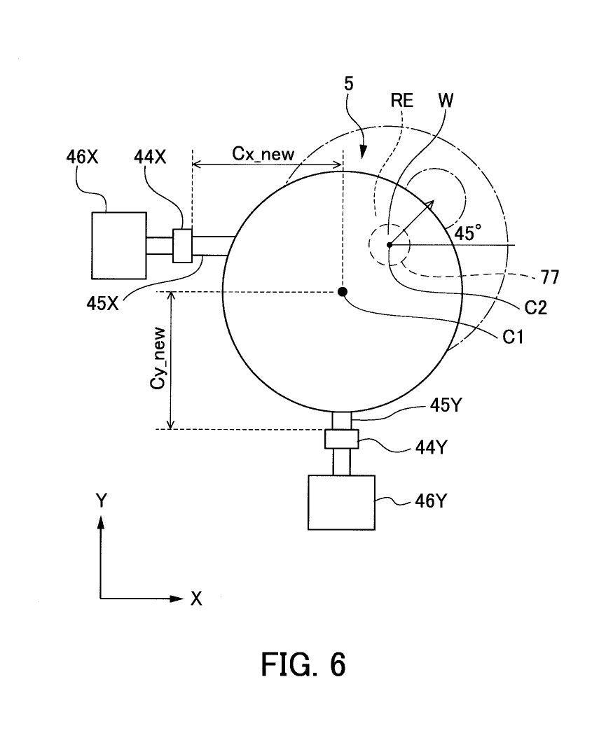

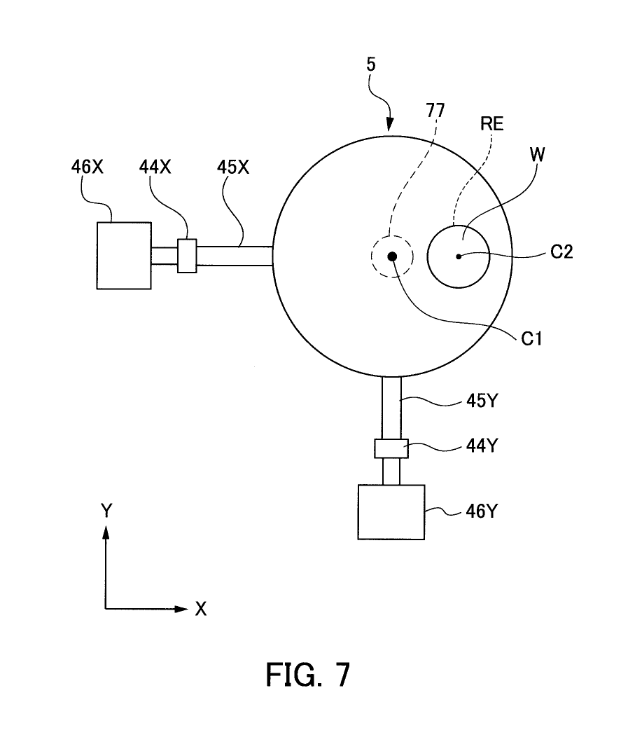

The control on the X axis servomotor 46X, the Y axis servomotor 46Y, the Z axis servomotor 46Z and the motor and the like forming the stage rotating device which is performed by the control device 8 will then be described. The control performed by the control device 8 when accuracy in the X axis direction and the Y axis direction is required will first be described with reference to FIGS. 3 to 6. The reason why, in this control, the work W is rotated such that θ is 45° will be described in detail later. The information that accuracy in the X axis direction and the Y axis direction is required is previously input from an input device such as a keyboard (unillustrated) before the start of the control performed by the control device 8. FIG. 4 is a flowchart showing the control performed by the control device 8 in the machining center 1 according to the embodiment of the present invention. FIG. 5 is a schematic plan view showing a state where the work table 5 in the machining center 1 according to the embodiment of the present invention is rotated such that the work W is arranged in the position of 45°. FIG. 6 is a schematic plan view showing a state where the work W is arranged in a position opposite the tool in the state where the work table 5 in the machining center 1 according to the embodiment of the present invention is moved such that the work W is located in the position of 45°. FIG. 7 is a schematic plan view showing a state where the work table 5 in the machining center 1 according to the embodiment of the present invention is rotated such that the work W is arranged in the position of 0°.

As shown in FIG. 4, in step S101, the control device 8 first determines whether or not the position relationship of the work table 5 and the work W is a position relationship in which the work W can be machined in the present embodiment. Specifically, the control device 8 first determines whether or not the work W is placed in the placement region RE in a state where the work W placed in the placement region RE is stably placed without falling down from the placement region RE of the work table 5, that is, in the present control, in a state where a half or more of the work W is not protruded outward of the work table 5 from the circumferential edge of the work table 5. Specifically, the control device 8 determines whether or not the diameter d and the distance r of the work table 5 (see FIG. 3) input from the input device such as a keyboard (unillustrated) satisfy a condition below.

0≤r≤d/2

When the circumferential edge of the work table 5 is located closest to the coupling 44X, the control device 8 also determines whether or not the position relationship is a position relationship in which the work W can be machined with the tool 77 of the spindle 75 in the X axis direction. Specifically, when the distance from the center of the tool 77 of the spindle 75 in the X axis direction indicated by a broken line circle in FIG. 3 to the coupling 44X is assumed to be Tx, the control device 8 determines whether or not the distance Tx satisfies a condition below.

Tx−r≥d/2

When the circumferential edge of the work table 5 is located closest to the coupling 44Y, the control device 8 also determines whether or not the position relationship is a position relationship in which the work W can be machined with the tool 77 of the spindle 75 in the Y axis direction. Specifically, when the distance from the center of the tool 77 of the spindle 75 in the Y axis direction indicated by the broken line circle in FIG. 3 to the coupling 44Y is assumed to be Ty, the control device 8 determines whether or not the distance Ty satisfies a condition below.

Ty−r≥d/2

When in step S101, as described above, the control device 8 determines that the position relationship of the work table 5 and the work W is the position relationship in which the work W can be machined in the present embodiment (YES), the processing performed by the control device 8 proceeds to step S102. When in step S101, the control device 8 determines that the position relationship of the work table 5 and the work W is not the position relationship in which the work W can be machined in the present embodiment (NO), the processing performed by the control device 8 proceeds to step S103.

In step S102, the control device 8 performs control in which the motor serving as the stage rotating device is driven to rotate the work table 5 such that with respect to a straight line extending from the center C1 of the work table 5 in a right direction in FIG. 3, an angle θ counterclockwise from the straight line extending from the center C1 of the work table 5 in the right direction in FIG. 3 to a straight line connecting together the center C1 of the work table 5 and the center C2 of the placement region RE is 45°. In step S103, the control device 8 performs control on a warning display device (unillustrated) such that the warning display device connected electrically to the control device 8 produces a display indicating that the position relationship of the work table 5 and the work W is not the position relationship in which the work W can be machined in the present embodiment.

In step S104, the control device 8 moves the work W placed on the work table 5 to a position opposite the tool 77 of the spindle 75 in the Z axis direction (up/down direction). Specifically, the control device 8 drives the X axis servomotor 46X so as to rotate the X axis ball screw axis 45X, and thereby moves the center C1 of the work table 5 in the X axis direction only by −r(cos 45°). The control device 8 also drives the Y axis servomotor 46Y so as to rotate the Y axis ball screw axis 45Y, and thereby moves the center C1 of the work table 5 in the Y axis direction only by −r(sin 45°). In this way, the center C1 of the work table 5 is located, in the X axis direction, in a position Cx_new (see FIG. 6) indicated by a formula below from the base end portion of the X axis ball screw axis 45X connected to the coupling 44X.

Tx−r(cos θ) (A)

Since θ=45°, the position Cx_new is located in Tx−r(cos 45°). The center C1 of the work table 5 is located, in the Y axis direction, in a position Cy_new indicated by a formula below from the base end portion of the Y axis ball screw axis 45Y connected to the coupling 44Y.

Tx−r(sin θ) (B)

Since θ=45°, the position Cy_new is located in Tx−r(sin 45°). Here, in the up/down direction, the work W is opposite the tool 77 of the spindle 75.

In step S105, the control device 8 performs control so as to drive the spindle motor 76 and thereby rotate the spindle 75. In this way, the tool 77 serving as the cutter at the lower end portion of the spindle 75 is moved in a downward direction so as to make contact with the work W, and thus the work W is machined. As described above, the control by the control device 8 for the machining of the work W is performed.

In order to minimize the influences of a temperature increase and a thermal displacement caused by heat generation resulting from friction when the X axis ball screw axis 45X and the Y axis ball screw axis 45Y are driven and to thereby enhance accuracy in the X axis direction and the Y axis direction, it is necessary to locate the center C1 of the work table 5 closest to the base end portion of the X axis ball screw axis 45X and to locate it closest to the base end portion of the Y axis ball screw axis 45Y. As described above, the center C1 of the work table 5 is located the distance indicated by (A) from the base end portion of the X axis ball screw axis 45X connected to the coupling 44X in the X axis direction and is located the distance indicated by (B) from the base end portion of the Y axis ball screw axis 45Y connected to the coupling 44Y in the Y axis direction.

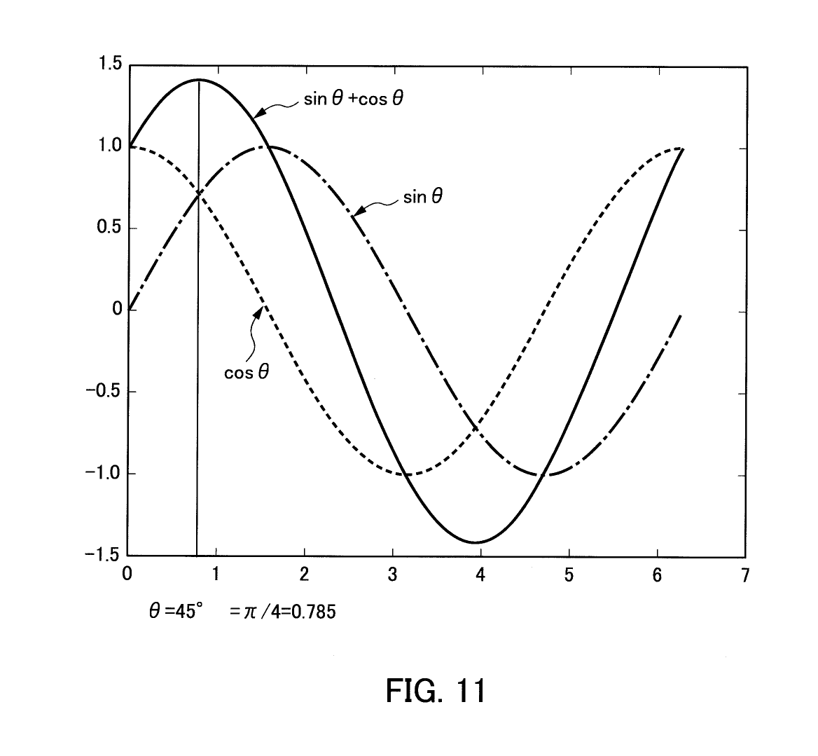

Hence, in order to decrease (A) and (B) in the X axis direction and the Y axis direction (minimize “Tx+Ty”), it is necessary to use the value of θ which maximizes sin θ+cos θ. It is found from FIG. 11 that the value of θ described above is 45°. Based on this, as described above, in step S102, the control device 8 performs control in which the work W is located in such a position as to rotate the work W by 45° such that when the center C2 of the placement region RE is arranged in a position opposite the tool 77 of the spindle 75 in the up/down direction, the sum of the two screw axis lengths of the X axis ball screw axis 45X and the Y axis ball screw axis 45Y, that is, the sum of the distance from the base end portion of the X axis ball screw axis 45X connected to the coupling 44X to the nut portion 47X and the distance from the base end portion of the Y axis ball screw axis 45Y connected to the coupling 44Y to the nut portion 47Y is minimized. FIG. 11 is a graph showing variations in the values of sin θ, cos θ and sin θ+cos θ when the angle by which the work table 5 in the machining center 1 according to the embodiment of the present invention is rotated is varied.

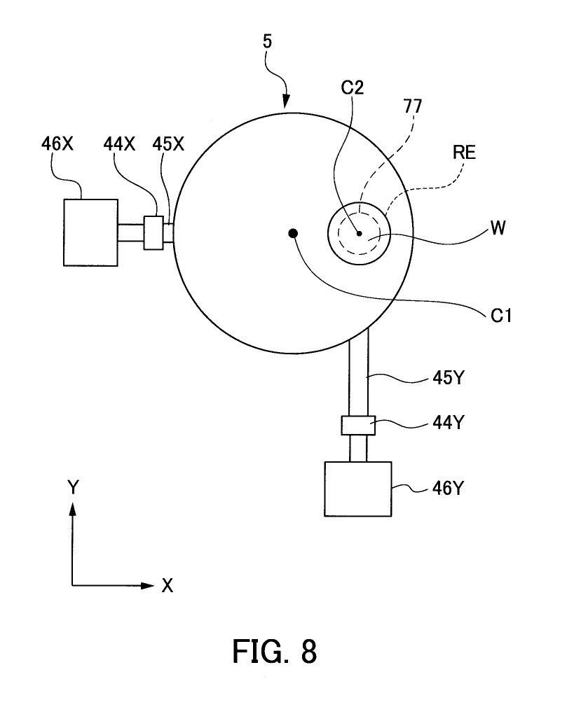

The control performed by the control device 8 when accuracy in the Y axis direction is not significantly required but accuracy in the X axis direction is required will then be described with reference to FIGS. 7 and 8. The reason why, in this control, the work W is rotated such that θ is 0° will be described in detail later. The information that accuracy in the Y axis direction is not significantly required but accuracy in the X axis direction is required is previously input from the input device such as a keyboard (unillustrated) before the start of the control performed by the control device 8. FIG. 7 is a schematic plan view showing a state where the work table 5 in the machining center 1 according to the embodiment of the present invention is rotated such that the work W is arranged in the position of 0°. FIG. 8 is a schematic plan view showing a state where the work W is arranged in a position opposite the tool in the state where the work table 5 in the machining center 1 according to the embodiment of the present invention is moved such that the work W is arranged in the position of 0°.

In the control performed by the control device 8 when accuracy in the X axis direction is required, the angle by which, in step S102 shown in FIG. 4, the work W is rotated differs from the angle by which, in step S102, the work W is rotated in the control performed by the control device 8 when accuracy in the X axis direction and the Y axis direction is required. Accordingly, the direction in which, in step S104, the work table 5 is moved also differs. The control performed by the control device 8 other than those described above is the same as the above-described control performed by the control device 8 when accuracy in the X axis direction and the Y axis direction is required, and thus the description thereof will be omitted unless otherwise described.

In step S102, the control device 8 performs control in which the motor serving as the stage rotating device is driven to rotate the work table 5 such that with respect to the straight line extending from the center C1 of the work table 5 in the right direction in FIG. 3, the angle θ formed by the straight line extending from the center C1 of the work table 5 in the right direction in FIG. 3 and the straight line connecting together the center C1 of the work table 5 and the center C2 of the placement region RE is 0° in the counterclockwise direction (see FIG. 7).

In step S104, the control device 8 moves the work W placed on the work table 5 to the position opposite the tool 77 of the spindle 75 in the up/down direction. Specifically, the control device 8 drives the X axis servomotor 46X so as to rotate the X axis ball screw axis 45X, and thereby moves the center C1 of the work table 5 in the X axis direction only by −r(cos 0°), that is, −r. In this way, the center C1 of the work table 5 is located, in the X axis direction, in a position indicated by a formula below from the base end portion of the X axis ball screw axis 45X connected to the coupling 44X.

Tx−r(cos θ) (A)

Since θ=0°, the center C1 is located in the position of Tx−r(cos 0°), that is, the position of Tx−r. Here, in the up/down direction, the work W is opposite the tool 77 of the spindle 75.

In order to minimize the influences of a temperature increase and a thermal displacement caused by heat generation resulting from friction when the X axis ball screw axis 45X is driven and to thereby enhance accuracy in the X axis direction, it is necessary to locate the center C1 of the work table 5 closest to the base end portion of the X axis ball screw axis 45X. As described above, the center C1 of the work table 5 is located the distance indicated by (A) from the base end portion of the X axis ball screw axis 45X connected to the coupling 44X in the X axis direction.

Hence, in order to decrease (A) in the X axis direction (minimize “Tx”), it is necessary to use the value of θ which maximizes cos θ. It is found from FIG. 11 that the value of θ described above is 0°. Based on this, as described above, in step S102, the control device 8 performs control in which the work W is located in such a position as to rotate the work W by 0° such that when the center C2 of the placement region RE is arranged in the position opposite the tool 77 of the spindle 75 in the up/down direction, the screw axis length of the X axis ball screw axis 45X, that is, the distance from the base end portion of the X axis ball screw axis 45X connected to the coupling 44X to the nut portion 47X is minimized.

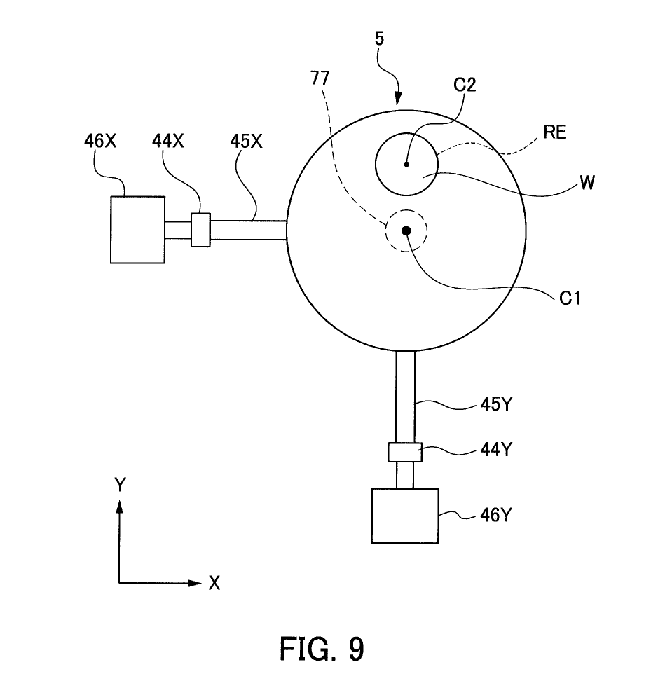

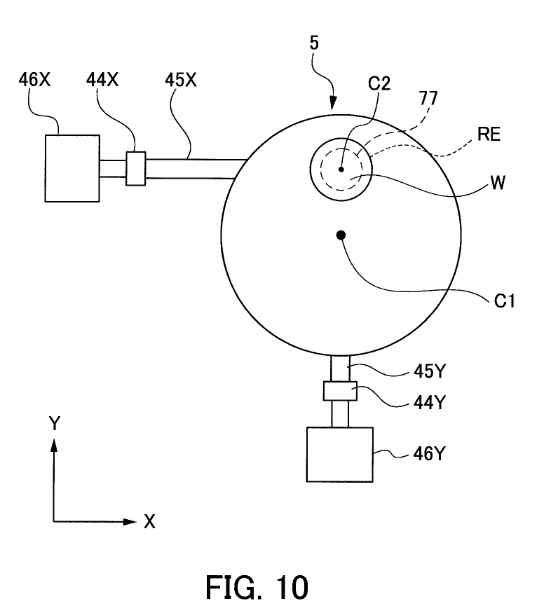

The control performed by the control device 8 when accuracy in the X axis direction is not significantly required but accuracy in the Y axis direction is required will then be described with reference to FIGS. 9 and 10. The reason why, in this control, the work W is rotated such that θ is 90° will be described in detail later. The information that accuracy in the X axis direction is not significantly required but accuracy in the Y axis direction is required is previously input from the input device such as a keyboard (unillustrated) before the start of the control performed by the control device 8. FIG. 9 is a schematic plan view showing a state where the work table 5 in the machining center 1 according to the embodiment of the present invention is rotated such that the work W is arranged in the position of 90°. FIG. 10 is a schematic plan view showing a state where the work W is arranged in a position opposite the tool in the state where the work table 5 in the machining center 1 according to the embodiment of the present invention is moved such that the work W is arranged in the position of 90°.

In the control performed by the control device 8 when accuracy in the Y axis direction is required, the angle by which, in step S102 shown in FIG. 4, the work W is rotated differs from the angle by which, in step S102, the work W is rotated in the control performed by the control device 8 when accuracy in the X axis direction and the Y axis direction is required. Accordingly, the direction in which, in step S104, the work table 5 is moved also differs. The control performed by the control device 8 other than those described above is the same as the above-described control performed by the control device 8 when accuracy in the X axis direction and the Y axis direction is required, and thus the description thereof will be omitted unless otherwise described.

In step S102, the control device 8 performs control in which the motor serving as the stage rotating device is driven to rotate the work table 5 such that with respect to the straight line extending from the center C1 of the work table 5 in the right direction in FIG. 3, the angle θ formed by the straight line extending from the center C1 of the work table 5 in the right direction in FIG. 3 and the straight line connecting together the center C1 of the work table 5 and the center C2 of the placement region RE is 90° in the counterclockwise direction (see FIG. 9).

In step S104, the control device 8 moves the work W placed on the work table 5 to the position opposite the tool 77 of the spindle 75 in the up/down direction. Specifically, the control device 8 drives the Y axis servomotor 46Y so as to rotate the Y axis ball screw axis 45Y, and thereby moves the center C1 of the work table 5 in the Y axis direction only by −r(sin 90°), that is, −r. In this way, the center C1 of the work table 5 is located, in the Y axis direction, in a position indicated by a formula below from the base end portion of the Y axis ball screw axis 45Y connected to the coupling 44Y.

Ty−r(sin θ) (B)

Since θ=90°, the center C1 is located in the position of Ty−r(sin 90°), that is, the position of Ty−r. Here, in the up/down direction, the work W is opposite the tool 77 of the spindle 75.

In order to minimize the influences of a temperature increase and a thermal displacement caused by heat generation resulting from friction when the Y axis ball screw axis 45Y is driven and to thereby enhance accuracy in the Y axis direction, it is necessary to locate the center C1 of the work table 5 closest to the base end portion of the Y axis ball screw axis 45Y. As described above, the center C1 of the work table 5 is located the distance indicated by (B) from the base end portion of the Y axis ball screw axis 45Y connected to the coupling 44Y in the Y axis direction.

Hence, in order to decrease (B) in the Y axis direction (minimize “Ty”), it is necessary to use the value of θ which maximizes sin θ. It is found from FIG. 11 that the value of θ described above is 90°. Based on this, as described above, in step S102, the control device 8 performs control in which the work W is located in such a position as to rotate the work W by 90° such that when the center C2 of the placement region RE is arranged in the position opposite the tool 77 of the spindle 75 in the up/down direction, the screw axis length of the Y axis ball screw axis 45Y, that is, the distance from the base end portion of the Y axis ball screw axis 45Y connected to the coupling 44Y to the nut portion 47Y is minimized.

As described above, in the present embodiment, the machining center 1 serving as the machine tool includes: the bed 2 and the column 3 serving as the machine tool main body; the X axis servomotor 46X, the Y axis servomotor 46Y and the Z axis servomotor 46Z serving as the axis member rotating device fixed to the bed 2 and the column 3; the stage axis portion (the table axis portion 51) having the table rotating axis as the rotating axis member supported rotatably with respect to the bed 2 and the column 3; the work table 5 which can be moved in the X axis direction that is the first direction and in the Y axis direction that is the second direction perpendicular to the X axis direction with respect to the bed 2 and the column 3, which is supported by the table axis portion 51 so as to be able to be rotated together with the table rotating axis and which includes the placement regions RE where a plurality of works W are respectively placed; the screw axis members (the X axis ball screw axis 45X and the Y axis ball screw axis 45Y) whose base portions are rotatably supported by the axis member rotating device; and the nut portions 47X and 47Y which are fixed to the table axis portion 51 and which are engaged with the portions on the tip portion sides of the screw axis members, and further includes: the ball screws whose screw axes are rotated by the X axis servomotor 46X and the Y axis servomotor 46Y such that the work table 5 is moved in the X axis direction and the Y axis direction; the motor serving as the stage rotating device which rotates the work table 5 through the table axis portion 51; the tool 77 serving as the spindle cutter which can be separated from and moved close to the work table 5 in the Z axis direction perpendicular to the X axis direction and the Y axis direction; and the control device 8 which controls the X axis servomotor 46X, the Y axis servomotor 46Y, the Z axis servomotor 46Z and the tool 77. The control device 8 performs control on the motor which rotates the X axis servomotor 46X, the Y axis servomotor 46Y and the work table so as to move the center C2 of the placement region RE in the work table 5 to a position opposite the tool 77 in the Z axis direction such that when the center C2 of the placement region RE in the work table 5 is arranged in the position opposite the tool 77 in the Z axis direction, in the X axis direction and the Y axis direction in which accuracy is required, the screw axis lengths from the couplings 44X and 44Y serving as the connection portions of the X axis ball screw axis 45X and the Y axis ball screw axis 45Y in the ball screws and the X axis servomotor 46X and the Y axis servomotor 46Y to the nut portions 47X and 47Y are minimized.

In this way, the lengths of the X axis ball screw axis 45X and the Y axis ball screw axis 45Y from the couplings 44X and 44Y to the nut portions 47X and 47Y are minimized. Consequently, it is possible to minimize the influences of a temperature increase and a thermal displacement caused by heat generation resulting from friction when the X axis ball screw axis 45X and the Y axis ball screw axis 45Y are driven, and thus it is possible to highly accurately perform machining with the tool 77. Hence, it is possible to obtain high machining accuracy by the simple control described above, and it is possible to adopt a configuration without need to provide a sensor or the like for detecting a thermal displacement, with the result that the cost related to the machining of the work W and the cost related to the machine tool can be reduced.

The two axis member rotating devices (the X axis servomotor 46X and the Y axis servomotor 46Y) and the two ball screws (the X axis ball screw axis 45X and the Y axis ball screw axis 45Y) are individually provided. The control device 8 performs control on the X axis ball screw axis 45X, the Y axis ball screw axis 45Y and the motor for rotating the work table such that when the center C2 of the placement region RE in the work table 5 is moved to the position opposite the tool 77 in the Z axis direction, the sum of the two screw axis lengths is minimized and that the center C2 of the placement region RE in the work table 5 is moved to the position opposite the tool 77 in the Z axis direction.

In this way, the sum of the lengths of the X axis ball screw axis 45X and the Y axis ball screw axis 45Y from the couplings 44X and 44Y to the nut portions 47X and 47Y is minimized. Consequently, even when accuracy is required both in the X axis direction and in the Y axis direction, the displacement of the accuracy to one of the X axis direction and the Y axis direction is reduced, with the result that it is possible to highly accurately machine the work W both in the X axis direction and in the Y axis direction.

Although the embodiment of the present invention is described above, the present invention is not limited to the embodiment described above. The effects described in the present embodiment are simply those which are obtained by listing the most preferred effects produced from the present invention, and thus the effects of the present invention are not limited to those described in the present embodiment.

For example, although the stage formed with the work table 5 can be moved both in the X axis direction which is the first direction and in the Y axis direction which is the second direction, there is no limitation to this configuration. For example, the stage can preferably be moved in at least one of the first direction and the second direction. Hence, in this case, the ball screw can preferably move the stage in at least one of the first direction and the second direction.

Although the work table 5 includes the four placement regions RE, there is no limitation to this configuration. For example, the work table 5 may include only one placement region RE. Although in the present embodiment, the distance between the center C2 of the placement region RE and the center C1 of the work table 5 is assumed to be r, there is no limitation to this configuration. For example, the distance between the position of part of the placement region RE and the center C1 of the work table 5 may be assumed to be r. In this case, when instead of the center C2 of the placement region RE, the part of the placement region RE is arranged in the position opposite the tool 77 serving as the spindle cutter in the Z axis direction, the control device 8 preferably performs the same control as in step S104 and step S105 described previously.

### EXPLANATION OF REFERENCE NUMERALS

1 machining center (machine tool)
2 bed (machine tool main body)
3 column (machine tool main body)
4 feed axis (screw axis member)
5 work table (stage)
7 spindle portion (spindle cutter)
8 control device
45X X axis ball screw axis (screw axis member)
45Y Y axis ball screw axis (screw axis member)
46X X axis servomotor (axis member rotating device)
46Y Y axis servomotor (axis member rotating device)
47X, 47Y, 47Z nut portion
51 table axis portion (stage axis portion)
77 tool (spindle cutter)
RE placement region
W work (item to be machined)

What is claimed is:

1. A machine tool comprising: a machine tool main body;
an axis member rotating device which is fixed to the machine tool main body;
a stage axis portion which includes a rotating axis member that is rotatably supported with respect to the machine tool main body;
a stage that is supported on the stage axis portion so as to be able to be moved with respect to the machine tool main body in at least one of a first direction and a second direction perpendicular to the first direction and to be able to be rotated together with the rotating axis member and that includes a placement region on which one or a plurality of items to be machined are respectively placed;
a ball screw whose base portion includes a screw axis member that is rotatably supported by the axis member rotating device and a nut portion that is fixed to the stage axis portion and that is engaged with a portion on a tip portion side of the screw axis member and which moves the stage in at least one of the first direction and the second direction by rotation of the screw axis member with the axis member rotating device;
a stage rotating device which rotates the stage through the stage axis portion;
a spindle cutter which can be separated from and moved close to the stage in a third direction perpendicular to the first direction and the second direction; and
a control device which controls the axis member rotating device and the spindle cutter,
wherein the control device performs control on the axis member rotating device and the stage rotating device such that when part of the placement region in the stage is arranged in a position opposite the spindle cutter in the third direction, in a direction which is at least one of the first direction and the second direction and in which accuracy is required, a screw axis length from a connection portion of the screw axis member of the ball screw and the axis member rotating device to the nut portion is minimized and that the part of the placement region in the stage is moved to the position opposite the spindle cutter in the third direction.

2. The machine tool according to claim 1, wherein the two axis member rotating devices and the two ball screws are provided,
a longitudinal direction of one of the screw axis members has a position relationship parallel to the first direction, and a longitudinal direction of the other of the screw axis members has a position relationship parallel to the second direction and
the control device performs control on the axis member rotating device and the stage rotating device such that when the part of the placement region in the stage is arranged in the position opposite the spindle cutter in the third direction, a sum of the two screw axis lengths is minimized and that the part of the placement region in the stage is moved to the position opposite the spindle cutter in the third direction.
